(19) United States
(12) Patent Application Publication
(10) Pub. No.: US 2014/0138316 A1
(43) Pub. Date: May 22, 2014

(54) METHOD OF MAKING AND USING AN ELECTRICALLY CONDUCTIVE COMPOSITE MEMBRANE

(71) Applicant: KING FAHD UNIVERSITY OF PETROLEUM AND MINERALS, Dhahran (SA)

(72) Inventors: RAFIL A. BASHEER, ROCHESTER HILLS, MI (US); NEDAL Y. ABU-THABIT, DHAHRAN (SA)

(73) Assignee: KING FAHD UNIVERSITY OF PETROLEUM AND MINERALS, DHAHRAN (SA)

(21) Appl. No.: 13/684,079

(22) Filed: Nov. 21, 2012

(51) Int. Cl. B05D 5/12; C02F 1/44

(52) U.S. Cl. CPC B05D 5/12; C02F 1/44
USPC 210/650; 427/122

(57) ABSTRACT

The method of making and using an electrically conductive composite membrane provides for manufacturing of an electrically conductive composite membrane for water sterilization. The electrically conductive composite membrane is made by first dipping cotton fiber into a graphite solution to form a cotton-graphite composite fiber. The cotton-graphite composite fiber is then coated with different silver nanostructures to form a cotton-graphite-silver composite material. The cotton-graphite-silver composite material may then be dipped into a solution containing a conducting polymer, thus forming the electrically conductive composite membrane. In use, the electrically conductive composite membrane is electrified by passing electrical current therethrough. Then, water to be sterilized is passed through the electrified electrically conductive composite membrane, producing potable drinking water.

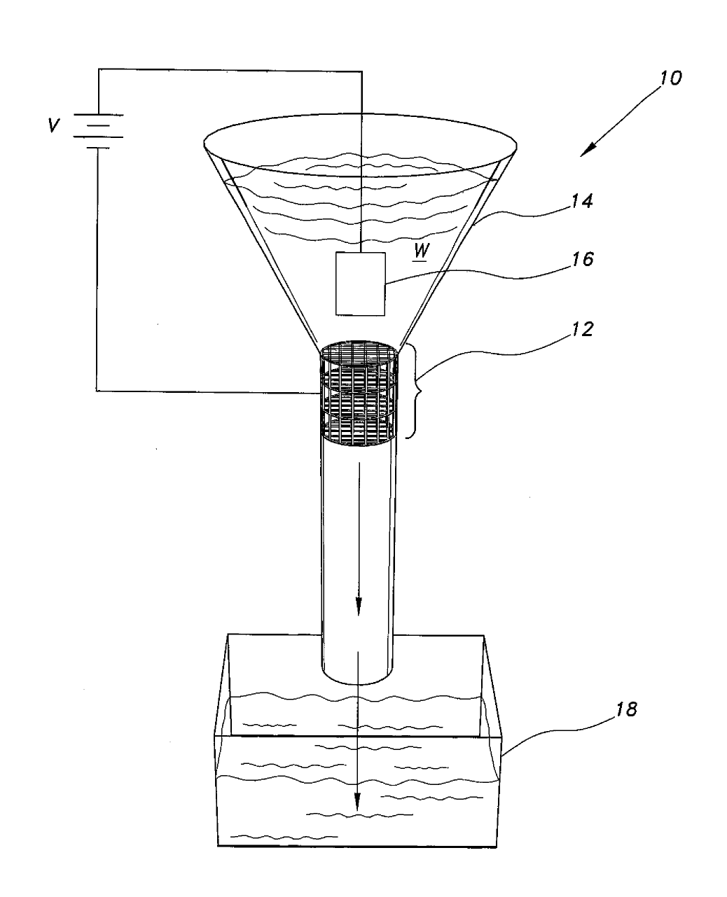

### BACKGROUND OF THE INVENTION

1. FIELD OF THE INVENTION

The method of making and using an electrically conductive composite membrane relates generally to the manufacture of an electrically conductive composite membrane for water sterilization, and to its use for the electrical sterilization of water and bacterial inactivation.

2. DESCRIPTION OF THE RELATED ART

The lack of potable water is a major problem in many areas of the world. A wide variety of sterilization and decontamination techniques exist for producing potable water. However, most are either difficult and/or costly to implement. The use of silver membrane filters for sterilization is of interest, primarily due to its portability, but the most effective form of silver for such purposes is nano-structures embedded in an electrically conductive composite membrane. Most nano-production methods are difficult and costly to implement.

Additionally, silver alone is not optimally effective. Thus, combinations of silver nano-structures with other antimicrobial materials and techniques are of further interest. However, given that the nano-structure basis of the material is already difficult to manufacture, adding further materials and techniques compounds the difficulty in providing a cost-effective and efficient electrically conductive composite membrane filter.

Thus, a method of making and using an electrically conductive composite membrane solving the aforementioned problems is desired.

### SUMMARY OF THE INVENTION

The method of making and using an electrically conductive composite membrane relates generally to the manufacture of an electrically conductive composite membrane for water sterilization, and to its use for the electrical sterilization of water and bacterial inactivation. The electrically conductive composite membrane is made from cotton fibers, graphite/carbon black and silver nanostructures. The silver nanostructures may be in the form of silver nanoparticles, silver nanowires, silver flakes, combinations thereof, or the like. The electrically conductive composite membrane is made by first dipping cotton fiber into a graphite solution to form a cotton-graphite composite fiber. The cotton-graphite composite fiber is then coated with silver nanostructures to form a cotton-graphite-silver composite material. The cotton-graphite-silver composite material may then be dipped into a solution containing a conducting polymer, and the cotton-graphite-silver composite material is formed into an electrically conductive composite membrane.

In use, the an electrically conductive composite membrane is electrified by passing electrical current therethrough. Then, water to be sterilized is passed through the electrified electrically conductive composite membrane, producing potable drinking water.

These and other features of the present invention will become readily apparent upon further review of the following specification and drawings.

### BRIEF DESCRIPTION OF THE DRAWINGS

The sole drawing Figure is an environmental perspective view of a device for testing an electrically conductive composite membrane.

Similar reference characters denote corresponding features consistently throughout the attached drawings.

### DETAILED DESCRIPTION OF THE PREFERRED EMBODIMENTS

The method of making and using an electrically conductive composite membrane relates generally to the manufacture of an electrically conductive composite membrane for water sterilization, and to its use for the sterilization of water. The electrically conductive composite membrane is made by first dipping cotton fiber into an aqueous or non-aqueous graphite solution or suspension to form a cotton-graphite composite fiber. The cotton-graphite composite fiber is then coated with silver nanostructures to form a cotton-graphite-silver composite material. The cotton-graphite-silver composite material may then be dipped into a solution containing a conducting polymer, and the cotton-graphite-silver composite material is formed into an electrically conductive composite membrane. The conducting polymer may be polythiophene, polypyrrole, polyaniline or the like.

Any suitable type of silver nanostructure may be utilized, such as silver nanowires, nanoparticles or the like. In an experiment, a solution of a mixture of silver nanoparticles and nanowires was produced by first placing 30 mL of ethylene glycol in a 125 mL Erlenmeyer flask, which was then heated in an oil bath at 160° C. for 30 minutes. A 240 μl aliquot of an aqueous solution of 4 mM CuCl₂ was then added and heated for another 15 minutes. To this reaction mixture, 9 mL of 114 mM polyvinylpyrrolidone solution was added, followed by the addition of 9 mL of freshly prepared 100 mM silver nitrate solution. The reaction continued for one additional hour, until the solution became wispy with a light brown color, indicating the formation of silver nanoparticles. The reaction was quenched by placing the flask in cold water. The silver nanoparticles and nanowires were then separated from suspension by centrifugation and washed with acetone and water. They were re-suspended in de-ionized water for further use.

Although any suitable type of natural or synthetic fiber may be utilized, such as cotton, wool, polyester, polyimide or glass fiber, cotton fiber is found to be the most effective. Similarly, although any suitable type of carbon solution or suspension may be used, graphite is found to be the most effective. As shown in Table 1 below, the artificial graphite material TC 307, manufactured by Asbury Carbons of Asbury, N.J., is found to be most effective. In Table 1, the superscript “a” refers to natural flake, the superscript “b” refers to surface enhanced synthetic graphite, the superscript “c” refers to bulk resistivity, and the superscript “d” refers to volume resistivity.

TABLE 1
Comparison of Carbon Materials

| | | | | Measured |
|---|---|---|---|---|
| | | | | composite |
| | | Surface | | Resistivity |
| Carbon | | Area | Resistance | with cotton |
| Material | Description | m²/g | (Ω/cm) | fibers (Ω/Sq) |
| 3243 | Flakes^{a} | 3.15 | 0.036^{c} | 300-10,000 |
| Graphite | | | | |
| 4827 | Synthetic^{b} | 248.92 | 0.261^{c} | 15-60 |
| Graphite | | | | |
| TC 307 | Primary | 352 | — | 15-30 |
| Graphite | Artificial | | | |
| 3442 | Flakes^{a} | 14.49 | 0.06^{c} | 35-250 |
| Graphite | | | | |
| PG06 | Sri Lankan | 8.75 | — | 100-900 |
| Graphite | | | | |
| ENSACO 250 | Synthetic | 66.1 | 5.8 ^{d} | 5-10 |
| Granular | | | | |
| Carbon Black | | | | |
| Alfa Aesar | | | | |
| 45527 | Synthetic | 75 | — | 50-70 |
| Carbon Black | | | | |

In another experiment, a 100 mg cotton sample was dipped into an aqueous solution containing the artificial graphite material TC 307. This process was repeated until a constant resistance was achieved of 30 Ω/sq. The prepared sample was then dried in an oven at 60° C. for one hour. The resultant cotton-graphite composite was dipped into an aqueous solution containing silver nanoparticles prepared as described above, and the resultant cotton-graphite-silver composite material was dried at 60° C. for one hour. The resistance of the prepared composite material was less than 0.1 Ω/sq.

It should be understood that, in the preparation, the cotton-graphite composite may be dried in air or in any inert gas, either with or without the application of vacuum, at a temperature ranging from room temperature to approximately 60° C. It should be similarly understood that following dipping into the aqueous or non-aqueous silver solution, the resultant composite fibers may be dried in air or in any inert gas, either with or without the application of vacuum, at a temperature ranging from room temperature to approximately 60° C.

Depending upon the particular method and materials, the resultant composite material is found to have a sheet resistance in the range of 0.001-100 Ω/sq. The overall silver metal content may range between approximately 0.0 and 90.0% by weight of the total composition. The resultant composite material is then formed into an electrically conductive composite membrane for water sterilization. In use, the electrically conductive composite membrane is electrified by passing electrical current therethrough. Then, water to be sterilized is passed through the electrified electrically conductive composite membrane, producing potable drinking water.

As shown in the sole Figure, the electrically conductive composite membrane 12 as prepared above is used as an electrode, which is positioned within a conduit, such as within exemplary funnel 14. A second conventional electrode 16 is also positioned within the funnel 14, such that potential source V generates an electrical path through the water W between electrodes 12, 16, and within the membrane electrode 12. Water passes through the membrane 12 and is collected in container 18.

In another experiment, 75 mg of the electrically conductive composite membrane was used as electrode 12, and placed in a plastic funnel with a 5 mm diameter (in the lower, thinner portion of the funnel) and with a length of 3 cm. Contaminated water samples containing a nominal E. Coli bacterial density of 10⁷-10⁸ CFU/ml, were passed through the membrane filter with an adjusted rate of 10 mL/min. In each experimental run, a 100 mL water sample was allowed to flow through the device 10 and the treated solution was diluted 1,000 times, from which 100 μL was plated. The device 10 was operated with an applied voltage of 20 V. The bacterial inactivation efficiency was found to be greater than 99.99% after the first run, with no E. Coil colonies observed in the second run.

The system 10 may be used for removal of common bacterial contamination of water, such as E. Coli, S. aureus, P. vulgaris and P. aeruginosa. The applied voltage is preferably in the range of ±100 V. The flow rate of the water passing through the electrically conductive composite membrane filter 12 may be between 10 and 10,000 mL/min., and the water may be passed therethrough any suitable number of times, with two or three runs being preferred.

It is to be understood that the present invention is not limited to the embodiments described above, but encompasses any and all embodiments within the scope of the following claims.

We claim:

1. A method of making an electrically conductive composite membrane, comprising the steps of:
dipping cotton fiber into a graphite solution to form a cotton-graphite composite fiber;
coating the cotton-graphite composite fiber with silver nanostructures to form a cotton-graphite-silver composite material; and
forming the cotton-graphite-silver composite material into an electrically conductive composite membrane.

2. The method of making an electrically conductive composite membrane as recited in claim 1, further comprising the step of dipping the cotton-graphite-silver composite material into a solution containing a conducting polymer.

3. The method of making an electrically conductive composite membrane as recited in claim 2, wherein the conducting polymer is selected from the group consisting of polythiophene, polypyrrole and polyaniline.

4. The method of making an electrically conductive composite membrane as recited in claim 1, wherein the step of dipping the cotton fiber into the graphite solution is repeated until the cotton-graphite composite fiber has a constant electrical resistance.

5. The method of making an electrically conductive composite membrane as recited in claim 4, wherein the step of dipping the cotton fiber into the graphite solution is repeated until the cotton-graphite composite fiber has a constant electrical resistance of approximately 30 Ω/sq.

6. The method of making an electrically conductive composite membrane as recited in claim 5, further comprising the step of drying the cotton-graphite composite fiber prior to the step of coating the cotton-graphite composite fiber with the silver nanostructures.

7. The method of making an electrically conductive composite membrane as recited in claim 6, wherein the cotton-graphite composite fiber is dried at a temperature of about 60° C. for a period of about one hour.

8. The method of making an electrically conductive composite membrane as recited in claim 1, further comprising the step of drying the cotton-graphite-silver composite material.

9. The method of making an electrically conductive composite membrane as recited in claim 8, wherein the cotton-graphite-silver composite material is dried at a temperature of about 60° C. for a period of about one hour.

10. A method of making an electrically conductive composite membrane, comprising the steps of:
dipping cotton fiber into a graphite solution to form a cotton-graphite composite fiber;
coating the cotton-graphite composite fiber with silver nanostructures to form a cotton-graphite-silver composite material;
dipping the cotton-graphite-silver composite material into a solution containing a conducting polymer; and
forming the cotton-graphite-silver composite material into an electrically conductive composite membrane.

11. The method of making an electrically conductive composite membrane as recited in claim 10, wherein the conducting polymer is selected from the group consisting of polythiophene, polypyrrole and polyaniline.

12. The method of making an electrically conductive composite membrane as recited in claim 11, wherein the step of dipping the cotton fiber into the graphite solution is repeated until the cotton-graphite composite fiber has a constant electrical resistance.

13. The method of making an electrically conductive composite membrane as recited in claim 12, wherein the step of dipping the cotton fiber into the graphite solution is repeated until the cotton-graphite composite fiber has a constant electrical resistance of approximately 30 Ω/sq.

14. The method of making an electrically conductive composite membrane as recited in claim 13, further comprising the step of drying the cotton-graphite composite fiber prior to the step of coating the cotton-graphite composite fiber with the silver nanostructures.

15. The method of making an electrically conductive composite membrane as recited in claim 14, wherein the cotton-graphite composite fiber is dried at a temperature of about 60° C. for a period of about one hour.

16. The method of making an electrically conductive composite membrane as recited in claim 10, further comprising the step of drying the cotton-graphite-silver composite material.

17. The method of making an electrically conductive composite membrane as recited in claim 16, wherein the cotton-graphite-silver composite material is dried at a temperature of about 60° C. for a period of about one hour.

18. A method of sterilizing water, comprising the steps of:
passing an electrical current through an electrically conductive composite membrane formed from a composite of cotton fiber, graphite and silver; and
passing water to be sterilized through the electrified electrically conductive composite membrane.
